(19) United States
(12) Patent Application Publication
(10) Pub. No.: US 2007/0132918 A1
(43) Pub. Date: Jun. 14, 2007

(54) Flat display

(76) Inventors: Chih-Liang Pan, Hsin-Chu (TW); Chun-Yen Chang, Hsin-Chu (TW); Han-Chang Cheng, Hsin-Chu (TW); Yang-En Wu, Hsin-Chu (TW); Ping-Chin Cheng, Hsin-Chu (TW); Lid-Joon Jong, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/603,883

(22) Filed: Nov. 24, 2006

(30) Foreign Application Priority Data
Nov. 25, 2005 (TW) 094141567

(51) Int. Cl. G02F 1/1335

(52) U.S. Cl. 349/96; 349/64

(57) ABSTRACT

A flat display, a flat panel display and a backlight module are disclosed. The flat display module comprises the flat panel display and the backlight module. The flat panel display comprises an upper polarizer and a lower polarizer. The lower polarizer includes a first diffusion layer. The backlight module comprises a light emitting device, a prism sheet and a light guide plate. A light beam is provided by the light emitting device. The prism sheet is one-dimensional prism array structure. The light guide plate includes a second diffusion layer for diffusing the light beam. The first diffusion layer has an optical haze greater than the optical haze of the surface of the upper polarizer. Accordingly, thin thickness and high brightness are achieved for the flat display.

### FIELD OF THE INVENTION

The present invention generally relates to a flat display, and more particularly to a flat display, a flat panel display and a backlight module, which includes a polarizer and a light guide plate.

### BACKGROUND OF THE INVENTION

Recently, thin display panels are applied for home appliances, communication apparatuses and computer apparatuses. A panel for use in a notebook computer could satisfy thin thickness and high brightness. In the prior arts, a prism sheet is usually assembled in a backlight module to concentrate light beam energy on an elevation angle by using a refraction way. Diffusion sheets are added at an upper portion or a lower portion of the prism sheet to uniform the light beam, thereby improving high brightness.

Referring to FIG. 1, a schematic diagram illustrates a conventional flat display module. The flat display module 10 includes a flat panel display 11 and a backlight module 12. The flat panel display 11 includes an upper polarizer 111, a lower polarizer 112, an upper substrate 113 and a lower substrate 114. The backlight module 12 includes a lamp 121, a first prism sheet 122, a second prism sheet 123, a light guide plate 124, a lamp reflection cap 125, a reflection sheet 126, a first diffusion sheet 127 and a second diffusion sheet 128. The lamp 121 is for providing a light beam. The first prism sheet 122 and the second prism sheet 123 are for reflecting or refracting the light beam in order to concentrate light beam energy on an elevation angle. The light beam is guided by the light guide plate 124 into the second diffusion sheet 128. The first diffusion sheet 127 and the second diffusion sheet 128 are for diffusing the light beam. The lamp reflection cap 125 surrounds the lamp tube 121 and is placed at a side of the light guide plate 124 for reflecting the light beam to the light guide plate 124. The reflection sheet 126 is arranged under the light guide plate 124 for reflecting the light beam to the light guide plate 124.

However, more optical sheets added into the backlight module would increase assembly time and are difficult in fastening. The weight and the thickness of a panel are further increased because the number of the optical sheets is also increased. In addition, the diffusion sheet may produce creases due to heat generated by the lamp. Therefore, a technique is then disclosed by removing the upper diffusion sheet and the lower diffusion sheet to reduce the weight and the thickness. However, uniformity of the backlight module may be decreased when diffusion sheets are removed. Shortcomings include surface deterioration, dirt and luminescent spots.

The inventor of the present invention based on years of experience on related research and development of the flat panel display invents flat display, a flat panel display and a backlight module to overcome the foregoing shortcomings.

### SUMMARY OF THE INVENTION

Accordingly, an object of the present invention is to provide a flat display with thin thickness and high brightness.

In accordance with the present invention a flat display includes a flat panel display and a backlight module. The flat panel display includes an upper polarizer and a lower polarizer. The lower polarizer has a first diffusion layer. The first diffusion layer has an optical haze greater than the optical haze of a surface of the upper polarizer. The backlight module includes a light emitting device, a first prism sheet and a light guide plate. The light emitting device provides a light beam. The first prism sheet has a one-dimensional prism array structure formed on a surface thereof. The light guide plate has a second diffusion layer for diffusing the light beam. The first diffusion layer has an optical haze greater than the optical haze of a surface of the upper polarizer

Other features and advantages of the present invention and variations thereof will become apparent from the following description, drawings, and claims.

### BRIEF DESCRIPTION OF THE DRAWINGS

FIG. 1 is a schematic diagram illustrating a conventional flat display module;

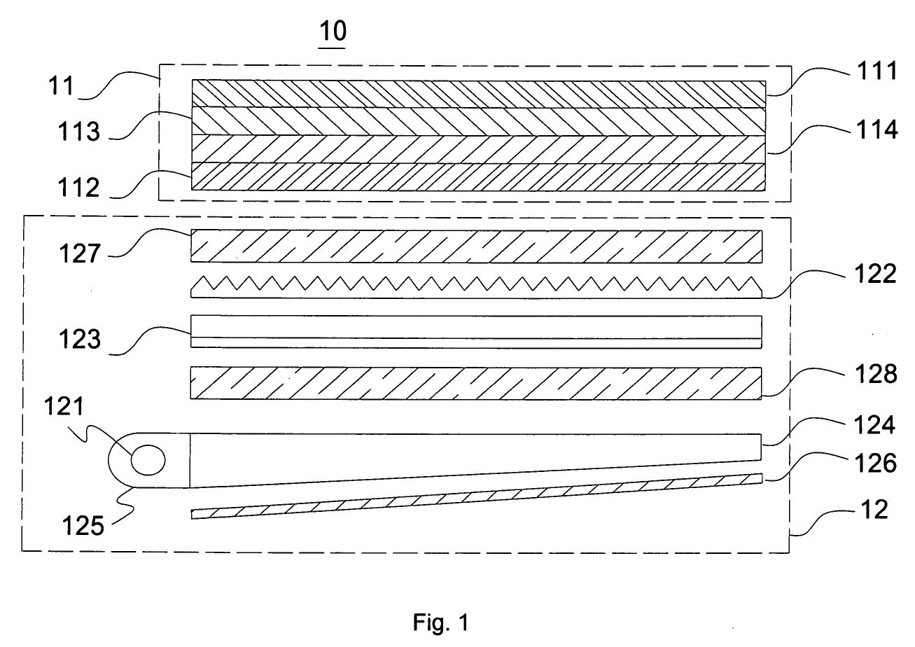

FIG. 2 is a schematic diagram illustrating a flat display according to an embodiment of the present invention;

FIG. 3 is a schematic diagram illustrating a flat display according to a preferred embodiment of the present invention;

FIG. 4 is a schematic diagram illustrating a flat display according to another preferred embodiment of the present invention;

FIG. 5 is a schematic diagram illustrating a flat display according to a further preferred embodiment of the present invention;

FIG. 6a is a perspective drawing illustrating a prism sheet according to an embodiment of the present invention; and

FIG. 6b is another perspective drawing illustrating the orthogonal arrangement for the first prism sheet and that of the second prism sheet according to an embodiment of the present invention.

### DETAILED DESCRIPTION OF THE PREFERRED EMBODIMENTS

To make it easier for our examiner to understand the objective of the invention, its innovative features and performance, a detailed description and technical characteristics of the present invention are described together with the drawings as follows.

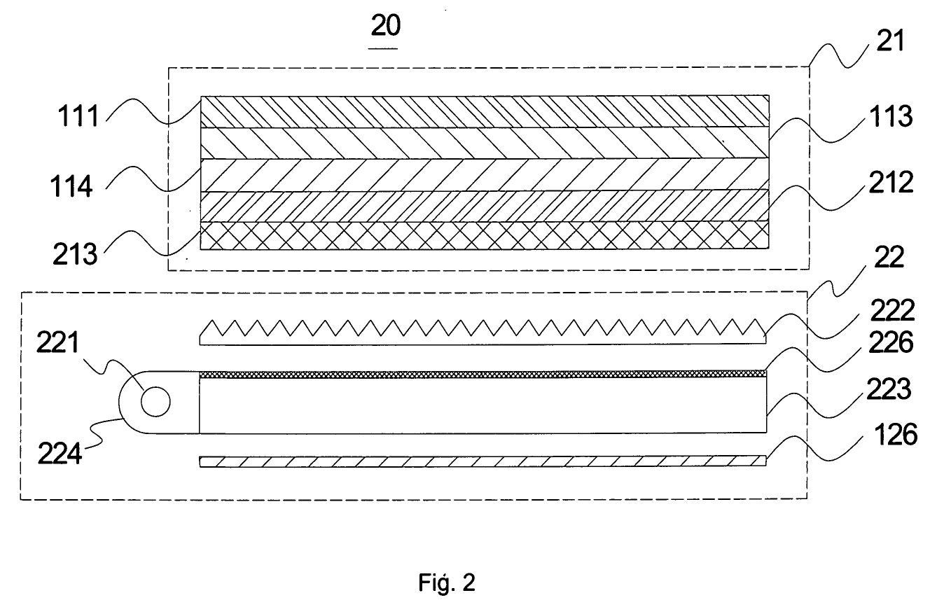

Referring to FIG. 2, a schematic diagram illustrates a flat display according to an embodiment of the present invention. The flat display 20 includes a flat panel display 21 and a backlight module 22. The flat panel display 21 includes an upper polarizer 111, a lower polarizer 212, an upper substrate 113 and a lower substrate 114. The lower polarizer 212 has a first diffusion layer 213. The first diffusion layer 213 has an optical haze greater than the optical haze of a surface of the upper polarizer 111. The first diffusion layer 213 has the optical haze between 20% and 60%. The upper polarizer 111 has a rough surface. A surface of the upper polarizer 111 is a lens.

The backlight module 22 includes a light emitting device 221, a prism component 222, a light guide plate 223, a reflection cap 224 and a reflection sheet 126. The light emitting device 221 is for providing a light beam. The prism component 222 is for reflecting or refracting the light beam. The light beam is guided by the light guide plate 223 into the prism component 222. The light guide plate 223 has a second diffusion layer 226 for diffusing the light beam. The reflection cap 224 surrounds the light emitting device 221 and is placed at a side of the light guide plate 223. The reflection cap 224 is for reflecting the light beam to the light guide plate 223. The reflection sheet 126 is arranged under the light guide plate 223 for reflecting the light beam to the light guide plate 223. The light emitting device 221 is a lamp. The prism component 222 is a prism sheet. The prism sheet has a one-dimensional prism array structure formed on a surface thereof for reflecting or refracting the light beam. Prism direction of the one-dimensional array structure is upward or downward. It should be noted the prism direction of the one-dimensional array structure as shown in FIG. 2 is upward. The second diffusion layer 226 has an optical haze between 50% and 95%. The second diffusion layer 226 has a rough surface or diffusion particles or dot patterns on a surface of the second diffusion layer 226.

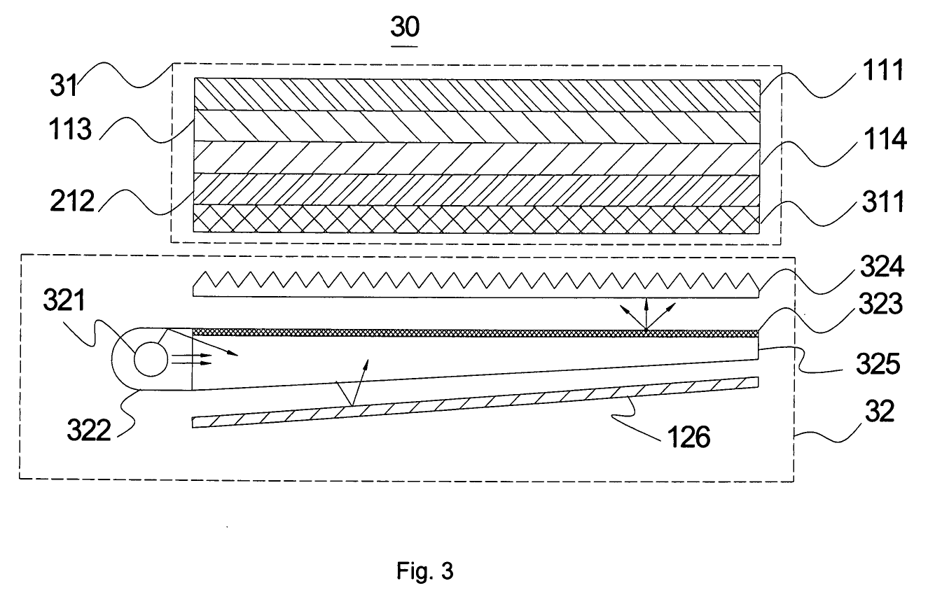

Referring to FIG. 3, a schematic diagram illustrates a flat display according to a preferred embodiment of the present invention. The flat display 30 includes a flat panel display 31 and a backlight module 32. The flat panel display 31 includes an upper polarizer 111, a lower polarizer 212, an upper substrate 113 and a lower substrate 114. The lower polarizer 212 has a first diffusion layer 311. The first diffusion layer 311 has an optical haze greater than the optical haze of a surface of the upper polarizer 211. The first diffusion layer 311 has the optical haze between 20% and 60%. The upper polarizer 111 has a rough surface.

The backlight module 32 includes a lamp 321, a first prism sheet 324, a light guide plate 325, a lamp reflection cap 322 and a reflection sheet 126. The lamp 321 is for providing a light beam. The first prism sheet 324 has a one-dimensional prism array structure formed on a surface thereof for reflecting or refracting the light beam. Prism direction of the one-dimensional prism array structure is upward. The light beam is guided by the light guide plate 325 into the first prism sheet 324. The light guide plate 325 has a second diffusion layer 323 for diffusing the light beam. The second diffusion layer 323 has an optical haze between 50% and 95%. The lamp reflection cap 322 surrounds the lamp 321 and is placed at a side of the light guide plate 325. The lamp reflection cap 322 is for reflecting the light beam to the light guide plate 325. The reflection sheet 126 is arranged under the light guide plate 325 for reflecting the light beam to the light guide plate 325.

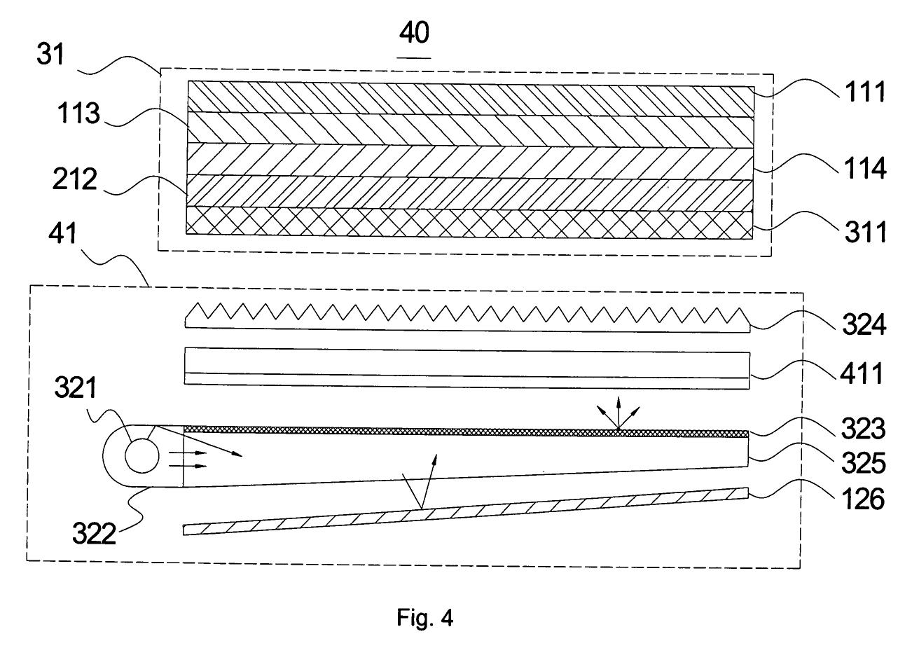

Referring to FIG. 4, a schematic diagram illustrates a flat display according to another preferred embodiment of the present invention. The flat display 40 includes a flat panel display 31 and a backlight module 41. The flat panel display 31 includes an upper polarizer 111, a lower polarizer 212, an upper substrate 113 and a lower substrate 114. The lower polarizer 212 has a first diffusion layer 311. The first diffusion layer 311 has an optical haze greater than the optical haze of a surface of the upper polarizer 111. The first diffusion layer 311 has the optical haze between 20% and 60%.

The backlight module 41 includes at least a lamp 321, a first prism sheet 324, a second prism sheet 411, a light guide plate 325, a lamp reflection cap 322 and a reflection sheet 126. The lamp 321 is for providing a light beam. The first prism sheet 324 has a one-dimensional prism array structure formed on a surface thereof for reflecting or refracting the light beam. The second prism sheet 411 has a one-dimensional prism array structure formed on a surface thereof. Prism directions of the one-dimensional prism array structure of the first prism sheet 324 and that of the second prism sheet 411 are upward. The one-dimensional prism array structure of the first prism sheet 324 and that of the second prism sheet 411 are orthogonal. The light beam is guided by the light guide plate 325 into the second prism sheet 411. The light guide plate 325 has a second diffusion layer 323 for diffusing the light beam. The second diffusion layer 323 has an optical haze between 50% and 95%. The lamp reflection cap 322 surrounds the lamp 321 and is placed at a side of the light guide plate 325 for reflecting the light beam to the light guide plate 325. The reflection sheet 126 is arranged under the light guide plate 325 for reflecting the light beam to the light guide plate 325.

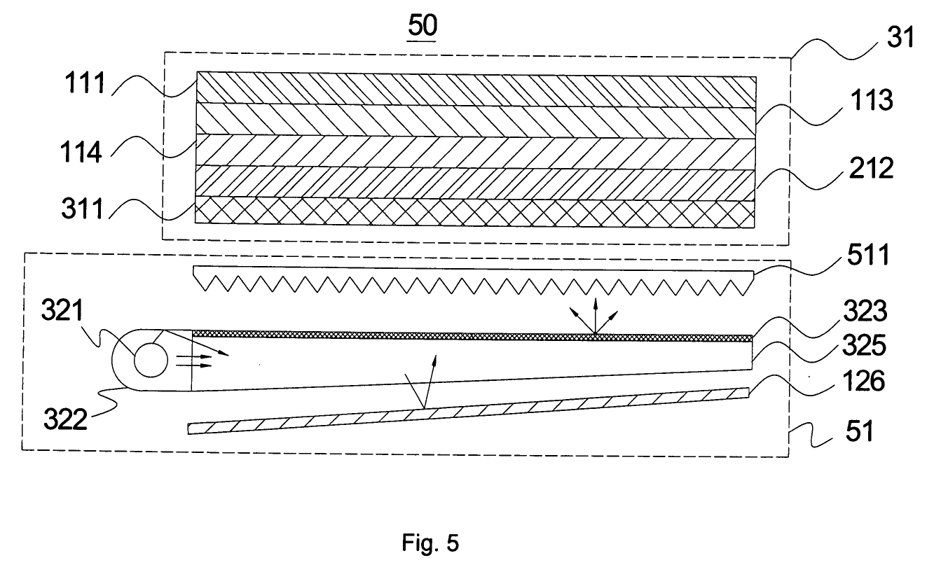

Referring FIG. 5, a schematic diagram illustrates a flat display according to a further preferred embodiment of the present invention. The flat display 50 includes a flat panel display 31 and a backlight module 51. The flat panel display 31 includes an upper polarizer 111, a lower polarizer 212, an upper substrate 113 and a lower substrate 114. The lower polarizer 212 has a first diffusion layer 311. The first diffusion layer 311 has an optical haze grater than the optical haze of a surface of the upper polarizer 111. The first diffusion layer 311 has the optical haze between 20% and 60%.

The backlight module 51 includes at least one lamp 321, a third prism sheet 511, a light guide plate 325, a lamp reflection cap 322 and a reflection sheet 126. The lamp 321 is for providing a light beam. The third prism sheet 511 has a one-dimensional prism array structure formed on a surface thereof for reflecting or refracting the light beam. Prism direction of the one-dimensional prism array structure of the third prism sheet 511 is downward. The light beam is guided by the light guide plate 325 into the third prism sheet 511. The light guide plate 325 has a second diffusion layer 323 for diffusing the light beam. The second diffusion layer 323 has an optical haze between 50% and 95%. The lamp reflection cap 322 surrounds the lamp tube 321 and is placed at a side of the light guide plate 325 for reflecting the light beam to the light guide plate 325. The reflection sheet 126 is arranged under the light guide plate 325 for reflecting the light beam to the light guide plate 325.

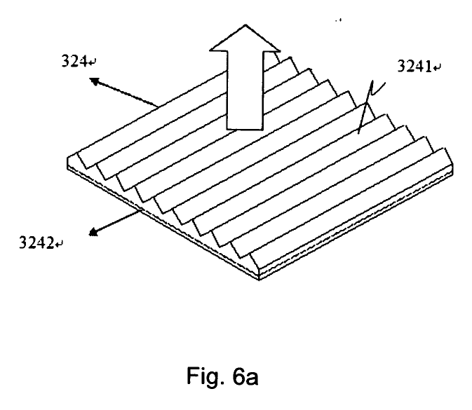

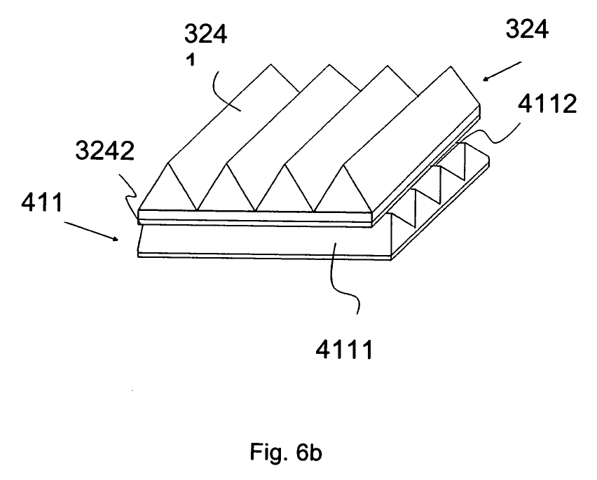

In FIG. 4, the arrangement for the first prism sheet 324 and the second prism sheet 411 is orthogonal. The orthogonal relation can be shown in FIG. 6a and FIG. 6b. FIG. 6a is a perspective drawing illustrating a prism sheet according to an embodiment of the present invention. FIG. 6b is another perspective drawing illustrating the orthogonal relation for the first prism sheet and the second prism sheet according to an embodiment of the present invention. The first prism sheet 324 is placed above the second prism sheet 411. The first prism sheet 324 has a plurality of triangle posts 3241 and a substrate 3242. The plurality of triangle posts 3241 is a wedge structure and is set on the substrate 3242. The arrangement of the plurality of triangle posts 3241 is mutual parallel arrangement. The second prism sheet 411 can also have a plurality of triangle posts 4111 the same as the first prism sheet. The plurality of triangle posts is a wedge structure. The arrangement for the plurality of triangles posts 4111 is a mutual parallel arrangement. However, the aforesaid arrangements for the first and the second prism sheets 324, 411 are formed ninety degree with orthogonal arrangement as illustration in FIG. 4. In another word, although the prism directions of the one-dimensional prism array structure are upward, the plurality of triangle posts 3241 of the first prism sheet 324 is vertical the plurality of triangle posts 4111 of the second prism sheet 411. Furthermore, the bottom of the substrate 3242 of the first prism sheet 324 corresponds to an apex 4112 of each triangle post of the second prism sheet 411. (Each triangle post has two inclination surfaces, which are extended from two hemlines of the bottom of each triangle post.)

Moreover, another flat display comprises a flat panel display and a backlight module. The flat panel display has an upper polarizer, a lower polarizer and a first diffusion layer. The first diffusion layer is disposed on the lower polarizer. The first diffusion layer has an optical haze greater than the optical haze of a surface of the upper polarizer. The backlight module has a light emitting device, a first prism sheet and a light guide plate. The light emitting device provides a light beam. The first prism sheet has a one-dimensional prism array structure formed on a surface thereof for reflecting or refracting the light beam. The light guide plate has a second diffusion layer for diffusing the light beam

In addition, a further flat display comprises a flat panel display and a backlight module. The flat panel display has an upper polarizer and a lower polarizer. The lower polarizer has a first diffusion layer. The first diffusion layer has an optical haze greater than the optical haze of a surface of the upper polarizer. The backlight module has a light emitting device, a first prism sheet, a light guide plate and a second diffusion layer. The second diffusion layer is disposed on the light guide plate. The light emitting device provides a light beam. The first prism sheet has a one-dimensional prism array structure formed on a surface thereof for reflecting or refracting the light beam. The second diffusion layer is for diffusing the light beam. Both the first diffusion layer and the second diffusion layer can be disposed or formed on the lower polarizer and the light guide plate.

The embodiment further considers the match of the transmittance axis direction of the lower polarizer 212 and the alignment axis of the third prism sheet 511. The transmission axis direction of the lower polarizer 212 usually includes 45 degree or 135 degree. To obtain better luminance and to reduce luminance variation for the flat display 50, the third prism sheet 511 between 45 degree and 90 degree of the alignment axis then is selected to match with the lower polarizer at 45 degree of the transmittance axis direction, and the third prism sheet 511 between 90 degree and 135 degree of the alignment axis is selected to match with the lower polarizer at 135 degree of the transmittance axis direction. The luminance is therefore enhanced and the luminance variation is reduced.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the description above, the present invention is novel and useful and definite enhances the performance over the conventional structure and further complies with the patent application requirements and is submitted to the Patent and Trademark Office for review and granting of the commensurate patent rights.

What is claimed is:

1. A flat display comprising:
a flat panel display having an upper polarizer and a lower polarizer, said lower polarizer having a first diffusion layer, wherein said first diffusion layer has an optical haze greater than the optical haze of a surface of said upper polarizer; and
a backlight module having a light emitting device, a first prism sheet and a light guide plate, wherein said light emitting device provides a light beam, and said first prism sheet has a one-dimensional prism array structure formed on a surface thereof for reflecting or refracting said light beam, and said light guide plate has a second diffusion layer for diffusing said light beam.

2. The flat display of claim 1, wherein prism direction of said one-dimensional prism array structure of said first prism sheet is downward.

3. The flat display of claim 1, wherein prism direction of said one-dimensional prism array structure of said first prism sheet is upward.

4. The flat display of claim 3, wherein said backlight module includes a second prism sheet.

5. The flat display of claim 4, wherein said second prism sheet has a one-dimensional prism array structure formed on a surface thereof, and prism direction of said one-dimensional prism array structure of said second prism sheet is upward.

6. The flat display of claim 5, wherein the one-dimensional prism array structure of said first prism sheet and that of said second prism sheet are orthogonal.

7. The flat display of claim 1, wherein a surface of said upper polarizer is a lens.

8. The flat display of claim 1, wherein said upper polarizer has a rough surface.

9. The flat display of claim 1, wherein said first diffusion layer has an optical haze between 20% and 60%.

10. The flat display of claim 1, wherein said second diffusion layer an optical haze between 50% and 95%.

11. The flat display of claim 1, wherein said second diffusion layer has a rough surface.

12. The flat display of claim 1, wherein said second diffusion layer has diffusion particles.

13. The flat display of claim 1, wherein said second diffusion layer has dot patterns on a surface of said second diffusion layer.

14. The flat display of claim 1, wherein when the transmittance axis direction of said lower polarizer is 45 degree, said first prism sheet between 45 degree and 90 degree of the alignment axis is selected to match with said lower polarizer.

15. The flat display of claim 1, wherein when the transmittance axis direction of said lower polarizer is 135 degree, said first prism sheet between 90 degree and 135 degree of the alignment axis is selected to match with said lower polarizer.

16. A flat display comprising:
an upper substrate;
a lower substrate adhered to said upper substrate;
an upper polarizer attached to said upper substrate;
a lower polarizer attached to said lower substrate, said lower polarizer having a first diffusion layer;
a light guide plate having a second diffusion layer; and
a first prism sheet disposed between said lower substrate and said light guide plate.

17. The flat display of claim 16, wherein said first diffusion layer has an optical haze greater than the optical haze of said upper polarizer.

18. The flat display of claim 16, wherein said first prism sheet is one-dimensional prism array structure with downward direction.

19. The flat display of claim 16, wherein said first prism sheet is one-dimensional prism array structure with upward direction.

20. The flat display of claim 16, wherein said flat display includes a second prism sheet, and said second prism sheet is one-dimensional prism array structure with upward direction, and the one-dimensional prism array structure of said first prism sheet and that of said second prism sheet are orthogonal.

21. The flat display of claim 16, wherein said first diffusion layer has an optical haze between 20% and 60%.

22. The flat display of claim 16, wherein said second diffusion layer has an optical haze between 50% and 95%.

23. The flat display of claim 16, wherein said second diffusion layer has diffusion particles.

24. The flat display of claim 16, wherein said second diffusion layer has dot patterns.

25. The flat display of claim 16, wherein when the transmittance axis direction of said lower polarizer is 45 degree, said first prism sheet between 45 degree and 90 degree of the alignment axis is selected to match with said lower polarizer.

26. The flat display of claim 16, wherein when the transmittance axis direction of said lower polarizer is 135 degree, said first prism sheet between 90 degree and 135 degree of the alignment axis is selected to match with said lower polarizer.

27. A flat display comprising:
a flat panel display having an upper polarizer, a lower polarizer and a first diffusion layer disposed on said lower polarizer, wherein said first diffusion layer has an optical haze greater than the optical haze of a surface of said upper polarizer; and
a backlight module having a light emitting device, a first prism sheet and a light guide plate, wherein said light emitting device provides a light beam, and said first prism sheet has a one-dimensional prism array structure formed on a surface thereof for reflecting or refracting said light beam, and said light guide plate has a second diffusion layer for diffusing said light beam.

28. The flat display of claim 27, wherein prism direction of said one-dimensional prism array structure of said first prism sheet is downward.

29. The flat display of claim 27, wherein prism direction of said one-dimensional prism array structure of said first prism sheet is upward.

30. The flat display of claim 27, wherein said backlight module includes a second prism sheet.

31. The flat display of claim 27, wherein said first diffusion layer has an optical haze between 20% and 60%.

32. The flat display of claim 27, wherein said second diffusion layer an optical haze between 50% and 95%.

33. The flat display of claim 27, wherein when the transmittance axis direction of said lower polarizer is 45 degree, said first prism sheet between 45 degree and 90 degree of the alignment axis is selected to match with said lower polarizer.

34. The flat display of claim 27, wherein when the transmittance axis direction of said lower polarizer is 135 degree, said first prism sheet between 90 degree and 135 degree of the alignment axis is selected to match with said lower polarizer.

35. A flat display comprising:
a flat panel display having an upper polarizer and a lower polarizer, said lower polarizer having a first diffusion layer, wherein said first diffusion layer has an optical haze greater than the optical haze of a surface of said upper polarizer; and
a backlight module having a light emitting device, a first prism sheet, a light guide plate and a second diffusion layer disposed on said light guide plate, wherein said light emitting device provides a light beam, and said first prism sheet has a one-dimensional prism array structure formed on a surface thereof for reflecting or refracting said light beam, and said second diffusion layer is for diffusing said light beam.

36. The flat display of claim 35, wherein prism direction of said one-dimensional prism array structure of said first prism sheet is downward.

37. The flat display of claim 35, wherein prism direction of said one-dimensional prism array structure of said first prism sheet is upward.

38. The flat display of claim 35, wherein said backlight module includes a second prism sheet.

39. The flat display of claim 35, wherein said first diffusion layer has an optical haze between 20% and 60%.

40. The flat display of claim 35, wherein said second diffusion layer an optical haze between 50% and 95%.

41. The flat display of claim 35, wherein when the transmittance axis direction of said lower polarizer is 45 degree, said first prism sheet between 45 degree and 90 degree of the alignment axis is selected to match with said lower polarizer.

42. The flat display of claim 35, wherein when the transmittance axis direction of said lower polarizer is 135 degree, said first prism sheet between 90 degree and 135 degree of the alignment axis is selected to match with said lower polarizer.

43. A flat display comprising:
a flat panel display having an upper polarizer, a lower polarizer and a first diffusion layer disposed on said lower polarizer, wherein said first diffusion layer has an optical haze greater than the optical haze of a surface of said upper polarizer; and
a backlight module having a light emitting device, a first prism sheet, a light guide plate and a second diffusion layer disposed on said light guide plate, wherein said light emitting device provides a light beam, and said first prism sheet has a one-dimensional prism array structure formed on a surface thereof for reflecting or refracting said light beam, and said second diffusion layer is for diffusing said light beam.

44. The flat display of claim 43, wherein prism direction of said one-dimensional prism array structure of said first prism sheet is downward.

45. The flat display of claim 43, wherein prism direction of said one-dimensional prism array structure of said first prism sheet is upward.

46. The flat display of claim 43, wherein said backlight module includes a second prism sheet.

47. The flat display of claim 43, wherein said first diffusion layer has an optical haze between 20% and 60%.

48. The flat display of claim 43, wherein said second diffusion layer an optical haze between 50% and 95%.

49. The flat display of claim 43, wherein when the transmittance axis direction of said lower polarizer is 45 degree, said first prism sheet between 45 degree and 90 degree of the alignment axis is selected to match with said lower polarizer.

50. The flat display of claim 43, wherein when the transmittance axis direction of said lower polarizer is 135 degree, said first prism sheet between 90 degree and 135 degree of the alignment axis is selected to match with said lower polarizer.
